(19) United States
(12) Patent Application Publication
(10) Pub. No.: US 2025/0171977 A1
(43) Pub. Date: May 29, 2025

(54) MANUFACTURING METHOD OF NOISE REDUCTION MODULE, NOISE REDUCTION MODULE, AND NOISE REDUCTION SCREEN

(71) Applicant: NATIONAL CHUNG SHAN INSTITUTE OF SCIENCE AND TECHNOLOGY, Taoyuan City (TW)

(72) Inventors: YI-KANG LAN, Taoyuan City (TW); SHI-YOU LIN, Taoyuan City (TW); SHU-HUNG HSU, Taoyuan City (TW); KAN-RU LIN, Taoyuan City (TW)

(21) Appl. No.: 18/519,100

(22) Filed: Nov. 27, 2023

(51) Int. Cl. E02D 13/00; B32B 5/18; B32B 25/04; B32B 25/08; B32B 27/06; B32B 27/08; B32B 27/18; B32B 27/40; B32B 37/18

(52) U.S. Cl. CPC E02D 13/005; B32B 5/18; B32B 25/042; B32B 25/045; B32B 25/08; B32B 27/065; B32B 27/08; B32B 27/18; B32B 27/40; B32B 37/18; B32B 2250/05; B32B 2264/10; B32B 2305/022; B32B 2307/102; B32B 2307/7376; B32B 2319/00; B32B 2375/00; B32B 2603/00

(57) ABSTRACT

A manufacturing method of a noise reduction module that is used underwater to attenuate low-frequency noise comprises steps of substrate preparation, functional layer fabrication, and encapsulation. The steps are performed by substrate preparation of functional layers of rubber and/or polyurethane, mixing sound-absorbing materials in the substrate material to constitute the sound-absorbing layer, and constituting the encapsulation layer by the substrate material, externally encapsulating the sound-absorbing layer by the encapsulation layer, in order to make into the noise reduction module in a modular structure, which can absorb the incoming sound wave energy by the sound-absorbing layer. The noise reduction screen can be composed of a plurality of the noise reduction modules.

### BACKGROUND OF THE INVENTION

### 1. Field of the Invention

The present disclosure provides an underwater noise reduction technology, and in particular a manufacturing method of a noise reduction module, a noise reduction module and a noise reduction screen for underwater noise reduction.

### 2. Description of the Related Art

The pile-driving engineering of offshore wind turbines will cause high-intensity low-frequency noise. In order to avoid such noise affecting marine ecology, it is stipulated that noise measurement points must be set up at 750 meters from the pile-driving point at sea during the construction period to carry out noise monitoring operations, and real-time feedback of the current noise measurement value and control the pile-driving force and noise.

At present, the protection of underwater noise of common offshore wind turbines mostly adopts the methods of hydro-sound-dampers (HSD) and bubble curtains. The hydro-sound-dampers noise reduction method is to use a large engineering ship to deploy a large network structure with rigid foam material to achieve a sound absorption effect. However, since the corresponding size of the holes in the rigid foam material is smaller than the main wavelength of pile-driving noise, the noise reduction is negatively affected. Furthermore, if the above-mentioned bubble curtain method is used, the engineering ship must carry a diesel generator to cooperate with the pile-driving operation throughout the whole process for deployment and pumping. However, because the bubbles will be affected by the tide and ocean current, the effect of attenuating low-frequency noise is poor. According to actual measurements, bubble curtain per layer only has a noise reduction effect of about −5 dB. To improve the noise reduction effect, a common approach is to add multiple layers of bubble curtains. However, the deployment and pumping of bubble curtains need to be accompanied by the operation of diesel engines and engineering ships, which in turn causes an increase of carbon dioxide emissions and energy consumption, which violates the purpose of erecting offshore wind turbines to apply green energy while being environmentally friendly and energy-saving.

### BRIEF SUMMARY OF THE INVENTION

The present disclosure provides a manufacturing method of a noise reduction module, a noise reduction module and a noise reduction screen, so as to reduce low-frequency noise during underwater construction.

In order to achieve the above objective and more, the present disclosure provides a manufacturing method of a noise reduction module, including steps of substrate preparation, functional layer fabrication, and encapsulation. The step of substrate preparation is substrate preparation of functional layers including a sound-absorbing layer and an encapsulation layer of rubber and/or polyurethane. The step of functional layer fabrication is mixing sound-absorbing materials in the substrate material to constitute the sound-absorbing layer, and constituting the encapsulation layer by the substrate material. The sound-absorbing material is selected from at least one of mica powder, alumina, zinc oxide, and barium sulfate. The step of encapsulation is externally encapsulating the sound-absorbing layer by the encapsulation layer, in order to make it into the noise reduction module to be able to absorb the incoming sound wave energy by the sound-absorbing layer.

In an embodiment, the step of functional layer fabrication further includes configuring a foaming structure in the base material to constitute a reflective layer, and in the step of encapsulation, the reflective layer is superimposed between the encapsulation layer and the sound-absorbing layer, and the reflective layer reflects the incoming sound wave energy.

In an embodiment, the step of functional layer fabrication further includes configuring the substrate material as a hollow structure and/or filling it with a counterweight material with a specific gravity higher than that of seawater to constitute a counterweight layer. In the step of encapsulation, the counterweight layer is superimposed between the encapsulation layer and the sound-absorbing layer, so that the noise reduction module is close to neutral buoyancy in seawater.

In an embodiment, the sound-absorbing material is a composition including mica powder, alumina, zinc oxide, barium sulfate, continuous alumina, and cork powder, wherein the weight percentage of mica powder is between 25% and 35%, the weight percentage of alumina is between 10% to 20%, the weight percentage of zinc oxide is between 15% and 25%, the weight percentage of barium sulfate is between 15% and 25%, and the weight percentage of continuous alumina is between 10% and 20%. The composition ratio of the components is selected according to the weight percentage of 100 percent.

In an embodiment, the rubber is selected from at least one of natural rubber (NR), nitrile butadiene rubber (NBR), and chloroprene rubber (CR).

The present disclosure also provides a noise reduction module, including a plurality of functional layers, each functional layer is constituted by rubber and/or polyurethane as a substrate material, including a sound-absorbing layer and an encapsulation layer. The sound-absorbing layer is constituted by mixing sound-absorbing materials in the substrate material, the sound-absorbing material is selected from at least one of mica powder, alumina, zinc oxide, and barium sulfate. The sound-absorbing layer is used to absorb the incoming sound wave energy. The encapsulation layer is for externally encapsulating the sound-absorbing layer.

In an embodiment, the plurality of functional layers further includes a reflective layer and a counterweight layer. The reflective layer and the counterweight layer are superimposed between the encapsulation layer and the sound-absorbing layer. The reflective layer is formed by configuring with a foaming structure in the substrate material, for reflecting the incoming sound wave energy. The counterweight layer is formed by configuring the substrate material as a hollow structure and/or filling it with a counterweight material with a specific gravity higher than that of seawater, so that the noise reduction module is close to neutral buoyancy in seawater.

In an embodiment, the reflective layer and the counterweight layer respectively have multiple layers corresponding to one layer of the sound-absorbing layer, and the multi-layer reflective layer and/or the multi-layer counterweight layer is provided symmetrically on two opposite sides of the corresponding sound-absorbing layer.

In an embodiment, the sound-absorbing layer has a thickness between 40 mm and 60 mm. The reflective layer has a thickness between 15 mm and 35 mm, and a specific gravity is between 0.1 and 0.7. The counterweight layer has a thickness between 3 mm and 8 mm, and a specific gravity between 1.8 and 4.

The present disclosure also provides a noise reduction screen, for attenuating the low-frequency noise of the pile-driving template of offshore wind turbines during underwater construction, including a plurality of noise reduction modules; and a suspended system, which is disposed around the pile-driving template according to the shape and size of the pile-driving template. The plurality of noise reduction modules are geometrically arranged in the suspended system and disposed around the pile-driving template.

In an embodiment, the plurality of noise reduction modules is alternately disposed in the suspended system in the lateral direction and/or longitudinal direction, and there is an empty space between the two adjacent noise reduction modules.

In an embodiment, the suspended system is provided with multiple sets of suspension sections along the perimeter of two bases above and below the pile-driving template. Each set of suspension section is in a group of two on the two bases and is positioned opposite to each other up and down. Multiple suspension components surround the two bases and are connected between each set of suspension sections, each noise reduction module has a plurality of suspension apertures and can be reassembled between any two adjacent suspension components.

Accordingly, the noise reduction module made by the manufacturing method of the present disclosure can effectively reduce the low-frequency noise generated during underwater construction to meet the requirements of environmental assessment. The noise reduction module assembled to be a noise reduction screen of the present disclosure is a modular structure and easy to assemble, so that the noise reduction module can be prepared and modularized on shore, and then carried to the construction site for underwater installation, so that the efficiency of underwater noise reduction construction can be improved.

Furthermore, through the plurality of suspension apertures, each noise reduction module can be reassembled between any two adjacent suspension components, so that the noise reduction module can be disassembled and reassembled, thereby achieving the effect of multiple recycling.

### BRIEF DESCRIPTION OF THE DRAWINGS

FIG. 1 is a flow chart of a manufacturing method according to an embodiment of the present disclosure.

FIG. 2 is a configuration diagram of a layered structure of a noise reduction module according to an embodiment of the present disclosure.

FIG. 3 is a sectional view of the layered structure of the noise reduction module according to an embodiment of the present disclosure.

FIG. 4 is a schematic view of a noise reduction screen provided on a pile-driving template for noise reduction according to an embodiment of the present disclosure.

FIG. 5 is a schematic view of the noise reduction modules alternately disposed on suspension components according to an embodiment of the present disclosure.

FIG. 6 is a line chart of a noise reduction effect tested by the noise reduction modules according to an embodiment of the present disclosure.

FIG. 7 is a line chart of a noise reduction effect tested by the noise reduction modules according to another embodiment of the present disclosure.

### DETAILED DESCRIPTION OF THE INVENTION

In order to fully understand the object, characteristics, and effect of the present disclosure, by means of the following specific embodiments, together with the attached drawings, the present disclosure is described in detail below.

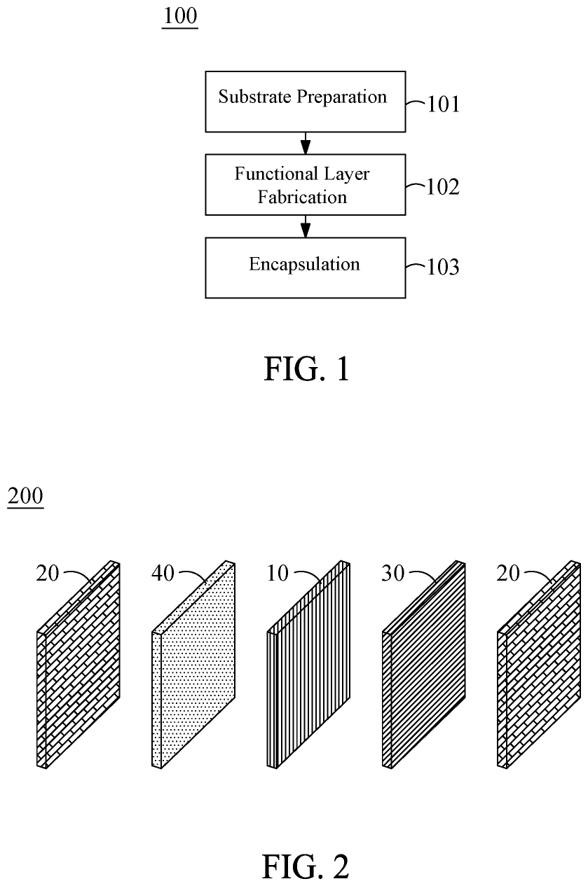

Referring to FIGS. 1 to 7, the present disclosure provides a manufacturing method 100 for a noise reduction module, a noise reduction module 200 and a noise reduction screen 300. The noise reduction module 200 is made by the manufacturing method 100, and the noise reduction screen 300 is assembled by a plurality of noise reduction modules 200. In an embodiment, it is applied to the underwater noise protection of the pile-driving engineering of offshore wind turbines, but the present disclosure is not limited to this application, and is described first.

The manufacturing method 100, as shown in FIG. 1, mainly includes steps of substrate preparation 101, functional layer fabrication 102, and encapsulation 103. Among them, the step of substrate preparation 101 is substrate preparation of a functional layer by rubber and/or polyurethane, whereby the substrate material makes the body of the functional layer elastic. In an embodiment, the rubber is selected from at least one of natural rubber (NR), nitrile butadiene rubber (NBR), and chloroprene rubber (CR).

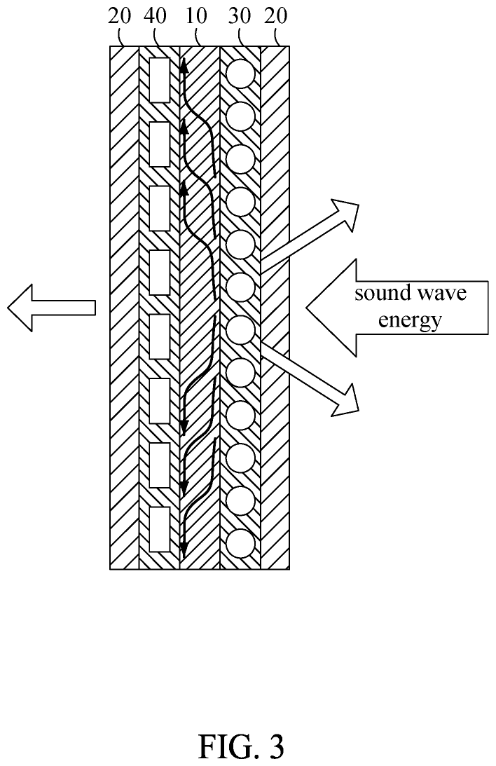

In an embodiment, the functional layers include a sound-absorbing layer 10 and an encapsulation layer 20, preferably as shown in FIGS. 2 and 3, including a reflective layer 30 and a counterweight layer 40. The sound-absorbing layer 10, the encapsulation layer 20, the reflective layer 30, and the counterweight layer 40 are all functional layers described in an embodiment of the present disclosure. The step of functional layer fabrication 102 is mixing sound-absorbing materials in the substrate material to form the sound-absorbing layer 10, and constituting the encapsulation layer 20 by the substrate material. The sound-absorbing material is selected from at least one of mica powder, alumina, zinc oxide, and barium sulfate. The test results of each component are that barium sulfate has preferable noise reduction performance in a test range of 5 kHz to 20 kHz, which may reach −20 dB at 18.5 kHz, while mica powder, alumina and zinc oxide may also achieve the effect of absorbing sound wave energy above −5 dB.

In an embodiment, the sound-absorbing material is a composition including mica powder, alumina, zinc oxide, barium sulfate, and continuous alumina, wherein the weight percentage of mica powder is between 25% and 35%, the weight percentage of alumina is between 10% to 20%, the weight percentage of zinc oxide is between 15% and 25%, the weight percentage of barium sulfate is between 15% and 25%, and the weight percentage of continuous alumina is between 10% and 20%. The composition ratio of the components is selected according to the weight percentage of 100 percent, and cork powder is added as necessary.

Specifically, the composition is mica powder by a weight percentage of 30%, alumina by a weight percentage of 15%, zinc oxide by a weight percentage of 20%, barium sulfate by a weight percentage of 20%, and continuous alumina by a weight percentage of 15%. Although cork powder is not added in this specific embodiment, the above components may be proportionally blended as necessary, and cork powder is added as one of the components.

The step of encapsulation 103 is externally encapsulating the sound-absorbing layer 10 by the encapsulation layer 20, thereby making it into the noise reduction module 200, and can absorb the incoming sound wave energy by the sound-absorbing layer 10.

In an embodiment, the step of functional layer fabrication 102 further includes configuring a foaming structure in the substrate material (referring to FIG. 3 together) to constitute a reflective layer 30, and configuring the base material as a hollow structure (referring to FIG. 3 together) to constitute a counterweight layer 40. In the step of encapsulation 103, the reflective layer 30 and the counterweight layer are superimposed between the encapsulation layer 20 and the sound-absorbing layer 10, and the reflective layer 30 reflects the incoming sound wave energy, and the counterweight layer 40 makes the noise reduction module 200 close to neutral buoyancy in seawater. In an embodiment, in addition to being a hollow structure, the counterweight layer can also be filled with a counterweight material with a specific gravity higher than that of seawater, or may have a hollow structure and be filled with a counterweight material with a specific gravity higher than that of seawater.

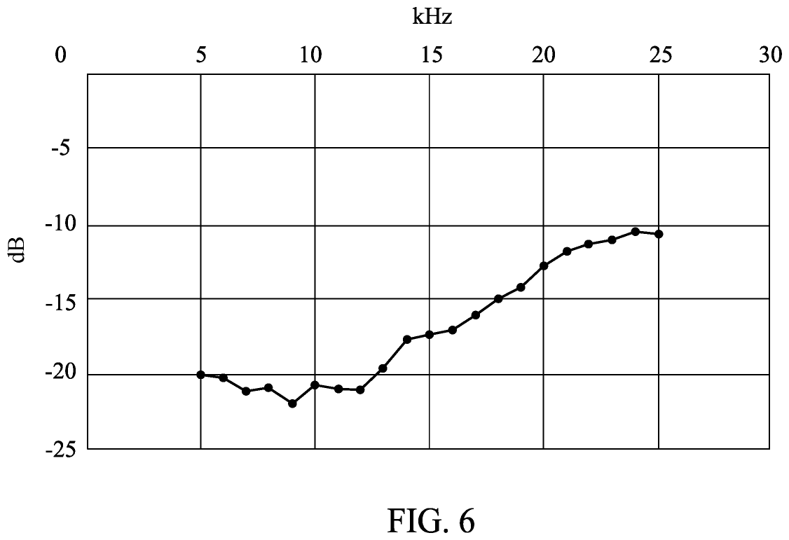

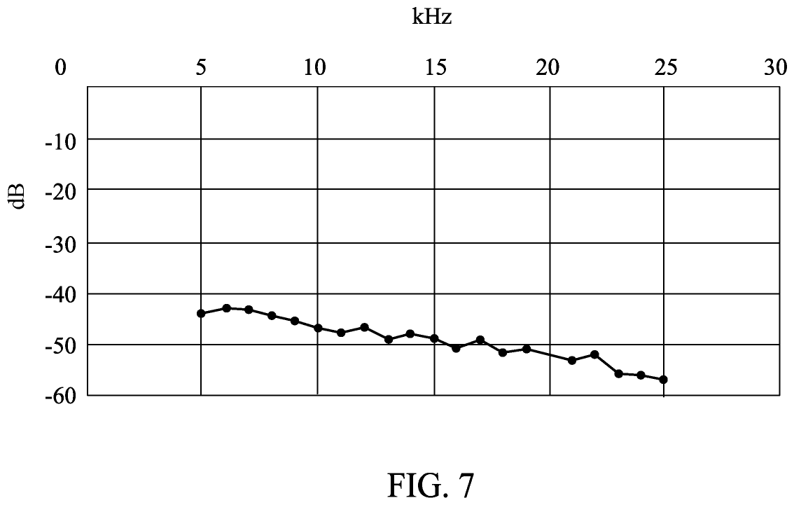

When the noise reduction module 200 is placed in seawater, it can have neutral buoyancy by the counterweight layer 40, so that the noise reduction module 200 is not floating or sinking in the position and similar to the positioning effect. When there is incoming sound wave energy, the sound wave energy is partially absorbed by the sound-absorbing layer 10, partially reflected by the reflection layer 30, and the rest penetrates the noise reduction module 200, and can achieve the effect of transmission loss of at least −15 dB. For example, when the noise reduction module 200 is formed by a sound-absorbing layer 10 packaged between two layers of the encapsulation layer 20, and a low-frequency noise test range of 5 kHz20 kHz is measured, the transmission loss can achieve a noise reduction effect of −20 Db, as shown in FIG. 6. For another example, when the noise reduction module 200 is formed by a sound-absorbing layer 10, a reflective layer 30, and a counterweight layer 40 packaged between two layers of the encapsulation layer 20, and the low-frequency noise test range of 5 kHz-20 kHz, the transmission loss can achieve a noise reduction effect of −40 dB, as shown in FIG. 7.

As described above, the noise reduction module 200 is formed by a five-layer structure including a sound-absorbing layer 10, two encapsulation layers 20, a reflective layer 30, and a counterweight layer 40. As shown in FIGS. 2 and 3, the sound-absorbing layer 10 is placed in the middle, and the reflective layer 30 and the counterweight layer 40 are symmetrically arranged on both sides of the sound-absorbing layer 10. Then, the two encapsulation layers 20 are tightly packaged on the outside of the reflective layer 30 and the counterweight layer 40, thereby constituting a modular structure. In different embodiments, the reflective layer 30 and the counterweight layer 40 of the noise reduction module 200 may also not be symmetrically arranged on both sides of the sound-absorbing layer 10. For example, the reflective layer 30 is placed in the middle, the counterweight layer 40 and the sound-absorbing layer 10 are disposed on both sides of the reflective layer 30. Alternatively, the counterweight layer 40 is placed in the middle, and the reflective layer 30 and the sound-absorbing layer 10 are placed on both sides of the counterweight layer 40. Further, the sound-absorbing layer 10, the encapsulation layer 20, the reflective layer 30, and the counterweight layer 40 included in the noise reduction module 200 may be respectively configured to be multiple as appropriate, and the encapsulation layers 20 are tightly packaged on the two outermost sides of the superimposed sound-absorbing layers 10, reflective layers 30, and counterweight layers 40.

In an embodiment, the sound-absorbing layer 10 has a thickness between 40 mm and 60 mm; the reflective layer 30 has a thickness between 15 mm and 35 mm, and a specific gravity is between 0.1 and 0.7; and the counterweight layer 40 has a thickness between 3 mm and 8 mm, and a specific gravity between 1.8 and 4. In an embodiment, the noise reduction module 200 including a sound-absorbing layer 10, two encapsulation layers 20, a reflective layer 30, and a counterweight layer 40 has a preferred total thickness of 50-100 mm.

As described above, after analyzing the operating conditions, maximum wind speed, and storm survival conditions of the noise reduction module 200 of the above embodiment, the analysis and calculation results show that the stress of the noise reduction module 200 in the overall model and the single-sided analysis model is between 1.42-8.15 N/mm², wherein the stress value of the storm survival condition is relatively large. The relevant components of the local model also have larger stress values in the storm survival condition, and the maximum stress is 48.4 N/mm², which confirms that the overall model and the single-sided model meet the requirements of operational strength.

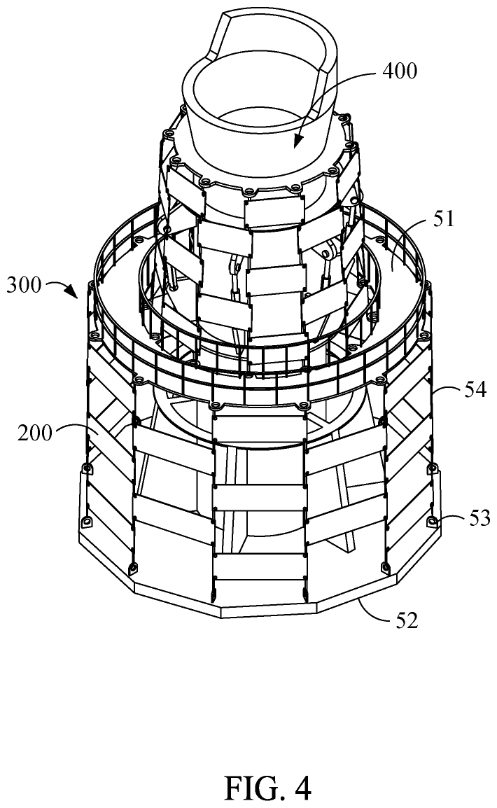

The present disclosure further provides a noise reduction screen 300, mainly includes a plurality of the aforementioned noise reduction module 200 and a suspended system 50. The suspended system 50 is located around a pile-driving template 400 according to the shape and size of the pile-driving template 400. As shown in FIG. 4, the pile-driving template 400 in an embodiment is a tripod pile used in piling, and the suspended system 50 is mounted on the pile-driving template 400. In an embodiment, the suspended system 50 includes multiple sets of suspension sections 53 and multiple suspension components 54. Both the multiple sets of suspension sections 53 and the multiple suspension components 54 are provided on the pile-driving template 400 and fixed to a base 51 located above, and another base 52 located below, and the shape of the base 51 and the base 52 is symmetrical and has polygon geometry. Among them, each set of suspension sections 53 has a suspension section 53 at the base 51 and the base 52 and is arranged at the corner oppositely up and down. The multiple suspension components 54 surround the base 51 and the base 52, and each suspension component 54 is connected between each set of suspension sections 53. As shown in FIG. 4, in an embodiment, the suspension component 54 is a chain, the hanging part 53 is an eye plate and is fixed to the base 51 and the base 52 through L-shaped steel welding. The suspension component 54 is fixed at each set of suspension section 53 by U-shaped bolts, and the noise reduction module 200 hangs from the suspension component 54.

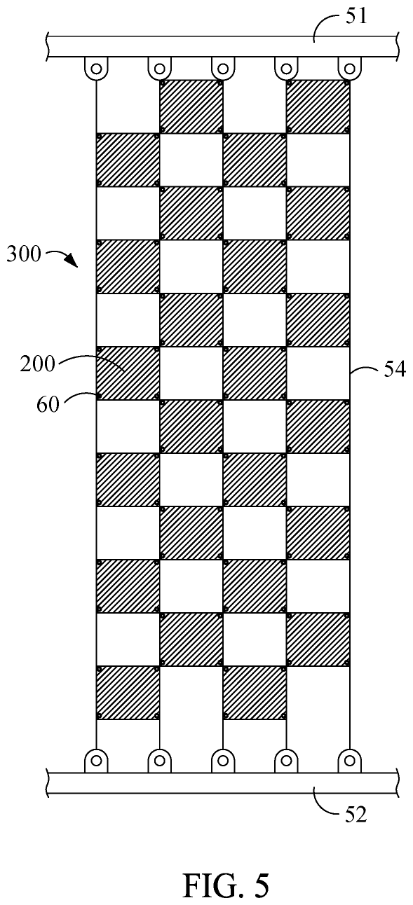

The plurality of noise reduction modules 200 are disposed between any two adjacent suspensions components 54. In an embodiment, each noise reduction module 200 has a plurality of suspension apertures 60, which can be reassembled between any two adjacent suspension components 54, and alternately disposed in the suspended system 50 in the lateral and longitudinal directions (referring to FIG. 5 together), and there is an empty space between two adjacent noise reduction modules 200. The noise reduction modules 200 and the empty space are arranged in a black and white configuration similar to a chess board. In different embodiments, the plurality of noise reduction modules 200 may not be disposed at intervals, but may be only arranged in the lateral direction and alternate in the longitudinal direction, or only arranged in the longitudinal direction and alternate in the lateral direction, or may be densely packed in the suspended system 50 in the lateral and longitudinal directions.

From the above description, it is not difficult to find that the features of the present disclosure are that the noise reduction module 200 made by the manufacturing method 100 of the present disclosure can absorb the low-frequency noise generated during underwater construction by the sound-absorbing layer 10 to meet environmental assessment requirements. The noise reduction module 200 of the present disclosure assembled in the suspended system 50 to be a noise reduction screen 300 is a modular structure and easy to assemble, so that the noise reduction module 200 can be prepared and modularized on shore. Afterwards, the suspended system 50 is mounted in the pile-driving template 400, and then carried to the construction site by a work boat for underwater installation, so that the efficiency of underwater noise reduction construction can be improved.

Furthermore, through the plurality of suspension apertures 60, each noise reduction module 200 can be reassembled on the suspension components 54 of the suspended system 50, so that the noise reduction module 200 can be disassembled with the pile-driving template 400 after the completion of the pile-driving template construction, and reassembled during another pile-driving template-construction to reduce noise, thereby achieving the effect of multiple recycling.

Thus, by theoretical calculation and modeling analysis results, combined with various experimental results, the manufacturing method 100 of the noise reduction module, the noise reduction module 200, and the noise reduction screen 300 of the present disclosure are designed, the noise reduction module 200 at least includes a sound-absorbing layer 10 and an encapsulation layer 20, preferably including a reflective layer 30 and a counterweight layer 40, and can achieve a transmission loss of at least −15 dB underwater and reduce low-frequency noise, which can improve construction efficiency and meet environmental assessment requirements. The present disclosure is suitable for elastomer systems such as rubber, develops a recyclable noise reduction module 200 to reduce carbon emissions and comply with the concept of recycling, can be applied to pile-driving template operation for harbor engineering and offshore wind turbines and other environments that require underwater noise reduction, and can reduce noise to meet environmental assessment requirements and reduce construction restrictions.

While the present invention has been described by means of preferable embodiments, those skilled in the art should understand the above description is merely embodiments of the invention, and it should not be considered to limit the scope of the invention. It should be noted that all changes and substitutions which come within the meaning and range of equivalency of the embodiments are intended to be embraced in the scope of the invention. Therefore, the scope of the invention is defined by the claims.

What is claimed is:

1. A manufacturing method of a noise reduction module, the noise reduction module is provided underwater to attenuate low-frequency noise, the manufacturing method comprises:
substrate preparation: substrate preparation of functional layers comprising a sound-absorbing layer and an encapsulation layer of rubber and/or polyurethane;
functional layer fabrication: mixing sound-absorbing materials in a substrate material to constitute the sound-absorbing layer, and constituting the encapsulation layer by the substrate material, the sound-absorbing material is selected from at least one of mica powder, alumina, zinc oxide, and barium sulfate; and
encapsulation: externally encapsulating the sound-absorbing layer by the encapsulation layer, in order to make the noise reduction module absorb incoming sound wave energy by the sound-absorbing layer.

2. The manufacturing method of a noise reduction module according to claim 1, wherein the step of functional layer fabrication further comprises configuring a foaming structure in the substrate material to constitute a reflective layer, and in the step of encapsulation, the reflective layer is superimposed between the encapsulation layer and the sound-absorbing layer, and the reflective layer reflects incoming sound wave energy.

3. The manufacturing method of a noise reduction module according to claim 2, wherein the step of functional layer fabrication further comprises configuring the substrate material as a hollow structure and/or filling with a counterweight material with a specific gravity higher than that of seawater to constitute a counterweight layer, and in the step of encapsulation, the reflective layer is superimposed between the encapsulation layer and the sound-absorbing layer, so that the noise reduction module is close to neutral buoyancy in seawater.

4. The manufacturing method of a noise reduction module according to claim 3, wherein the sound-absorbing material is a composition comprising mica powder, alumina, zinc oxide, barium sulfate, and continuous alumina, wherein a weight percentage of mica powder is between 25% and 35%, a weight percentage of alumina is between 10% to 20%, a weight percentage of zinc oxide is between 15% and 25%, a weight percentage of barium sulfate is between 15% and 25%, and a weight percentage of continuous alumina is between 10% and 20%, the composition ratio of the components is selected according to the weight percentage of 100 percent.

5. The manufacturing method of a noise reduction module according to claim 1, wherein the rubber is selected from at least one of natural rubber (NR), nitrile butadiene rubber (NBR), and chloroprene rubber (CR).

6. A noise reduction module, used to attenuate underwater low-frequency noise, the noise reduction module comprises a plurality of functional layers, each functional layer is constituted by rubber and/or polyurethane as a substrate material, comprising:
a sound-absorbing layer, constituted by mixing sound-absorbing materials in the substrate material, the sound-absorbing material is selected from at least one of mica powder, alumina, zinc oxide, and barium sulfate, the sound-absorbing layer is used to absorb incoming sound wave energy; and
an encapsulation layer, the encapsulation layer is for externally encapsulating the sound-absorbing layer.

7. The noise reduction module according to claim 6, wherein the plurality of functional layers further comprises a reflective layer and a counterweight layer, the reflective layer and the counterweight layer are superimposed between the encapsulation layer and the sound-absorbing layer, wherein the reflective layer is formed by configuring with a foaming structure in the substrate material, for reflecting incoming sound wave energy; the counterweight layer is formed by configuring the substrate material as a hollow structure and/or filling with a counterweight material with a specific gravity higher than that of seawater, so that the noise reduction module is close to neutral buoyancy in seawater.

8. The noise reduction module according to claim 7, wherein the reflective layer and the counterweight layer respectively have multiple layers corresponding to one layer of the sound-absorbing layer, and the multi-layer reflective layer and/or the multi-layer counterweight layer is provided symmetrically on two opposite sides of the corresponding sound-absorbing layer.

9. The noise reduction module according to claim 8, wherein the sound-absorbing layer has a thickness between 40 mm and 60 mm; the reflective layer has a thickness between 15 mm and 35 mm, and a specific gravity is between 0.1 and 0.7; and the counterweight layer has a thickness between 3 mm and 8 mm, and a specific gravity between 1.8 and 4.

10. A noise reduction screen, for attenuating low-frequency noise of a pile-driving of offshore wind turbines during underwater construction, comprising:
a plurality of noise reduction modules according to claim 7; and
a suspended system, disposed around the pile-driving template according to the shape and size of the pile, the plurality of noise reduction modules are geometrically arranged in the suspended system and disposed around the pile-driving template.

11. The noise reduction screen according to claim 10, wherein the plurality of noise reduction modules are alternately disposed in the suspended system in the lateral direction and/or longitudinal direction, and there is an empty space between two adjacent noise reduction modules.

12. The noise reduction screen according to claim 11, wherein the suspended system is provided with multiple sets of suspension sections along a perimeter of two bases above and below the pile-driving template, each set of suspension sections is in a group of two on the two bases and is positioned opposite to each other up and down, multiple suspension components surround the two bases and are connected between each set of suspension section, each noise reduction module has a plurality of suspension apertures and can be reassembled between any two adjacent suspension components.

13. A noise reduction screen, for attenuating low-frequency noise of a pile-driving of offshore wind turbines during underwater construction, comprising:
a plurality of noise reduction modules according to claim 8; and
a suspended system, disposed around the pile-driving template according to the shape and size of the pile, the plurality of noise reduction modules are geometrically arranged in the suspended system and disposed around the pile-driving template.

14. The noise reduction screen according to claim 13, wherein the plurality of noise reduction modules are alternately disposed in the suspended system in the lateral direction and/or longitudinal direction, and there is an empty space between two adjacent noise reduction modules.

15. The noise reduction screen according to claim 14, wherein the suspended system is provided with multiple sets of suspension sections along a perimeter of two bases above and below the pile-driving template, each set of suspension sections is in a group of two on the two bases and is positioned opposite to each other up and down, multiple suspension components surround the two bases and are connected between each set of suspension section, each noise reduction module has a plurality of suspension apertures and can be reassembled between any two adjacent suspension components.

16. A noise reduction screen, for attenuating low-frequency noise of a pile-driving of offshore wind turbines during underwater construction, comprising:
a plurality of noise reduction modules according to claim 9; and
a suspended system, disposed around the pile-driving template according to the shape and size of the pile, the plurality of noise reduction modules are geometrically arranged in the suspended system and disposed around the pile-driving template.

17. The noise reduction screen according to claim 16, wherein the plurality of noise reduction modules are alternately disposed in the suspended system in the lateral direction and/or longitudinal direction, and there is an empty space between two adjacent noise reduction modules.

18. The noise reduction screen according to claim 17, wherein the suspended system is provided with multiple sets of suspension sections along a perimeter of two bases above and below the pile-driving template, each set of suspension sections is in a group of two on the two bases and is positioned opposite to each other up and down, multiple suspension components surround the two bases and are connected between each set of suspension section, each noise reduction module has a plurality of suspension apertures and can be reassembled between any two adjacent suspension components.
